(19) United States
(12) Patent Application Publication
(10) Pub. No.: US 2023/0392720 A1
(43) Pub. Date: Dec. 7, 2023

(54) CPVC MULTILAYER COMPOSITE PIPE WITH IMPROVED TEMPERATURE AND DELAMINATION RESISTANCE AND PROCESS FOR MAKING PIPE

(71) Applicant: ASTRAL LIMITED, Ahmedabad (IN)

(72) Inventor: Sandeep Pravinbhai ENGINEER, Ahmedabad (IN)

(21) Appl. No.: 18/248,476

(22) PCT Filed: Oct. 9, 2021
(86) PCT No.: PCT/IN2021/050973

§ 371 Date: Apr. 10, 2023

(30) Foreign Application Priority Data
Oct. 10, 2020 (IN) 202021044182

(51) Int. Cl. F16L 9/147; B29C 48/00; B29C 48/09

(52) U.S. Cl. CPC F16L 9/147; B29C 48/0021; B29C 48/09; B29C 48/022; B29K 2027/06

(57) ABSTRACT

The present invention relates to aCPVC multilayer composite pipe with improved impact resistance, temperature resistance and de-lamination resistance and process for making pipe. The present invention provides composite pipe with altered thickness having two conduits of CPVC separated by metal conduit. The invention provides pipe with multilayered structure having metal interlayer firm engagement through adhesive application. The process provides inventive intact arrangement of two different materials that are generally difficult to resists for clasping together in circular compact system specifically at elevated stressed conditions (i.e. temperature and pressure). In the current state of the art composite pipe manufacturing reflects de-lamination of the layers closely held together with adhesive application at interlayer. The present invention discloses CPVC composition along with adhesive which collectively provides superlative quality of holding dual layers of CPVC conduits with metal interlayer and low expansion to the pipe during elevated temperature and pressure conditions.

### FIELD OF INVENTION

The present invention relates to CPVC multilayer composite pipe and, more particularly, to it relates CPVC multilayer composite pipe with improved impact resistance, temperature resistance and de-lamination resistance and process for making pipe for residential, commercial of Industrial Application.

### BACKGROUND OF INVENTION

Composite pipes can be manufactured to specific needs depending on the conditions to which it will be subjected. They can also be cut into desired lengths of segments making it convenient to install. They can be made strong enough to withstand structural settlement, high surge pressure and seismic loads.

These pipes have low coefficient of thermal expansion, thus limiting pipe movement, making it an ideal material to be used in places with high temperature variation. These pipes are non-corrosive; do not require cathodic protection and are resistant to acidic and sulphurous sewer environment. The smooth internal surface of these pipes prevents buildup of solid material, and the growth of bacteria and microbes, eliminating conditions like tuberculation. Clearing blockages using pressure jets and other methods is easier in composite pipes than in pipes of other material. The lifespan of composite pipe is between 50 to 100 years.

Despite many variations of hybrid and composite pipes and fittings, all of these pipes are deficient in that they do not balance the properties of both metal pipes and plastic pipes. A need still exists for a rigid, pressure bearing, impact resistant, multilayer thermoplastic composite pipe which can be easily installed. There is a great need for a multilayer composite pipe that balances both the properties of metal pipes and plastic pipes. Furthermore, a need exists for a fluid conduit system in which such a multilayer composite pipe can be used.

Typically, piping systems are made up of a number of components including straight or curved pipe sections, fittings (e.g. elbow fittings), valves, etc. to provide an interior flow path for the liquid being conveyed. Typically, a piping system (such as a system comprising thermoplastic pipes), is assembled such that the components are joined in a manner that provides a durable connection that prevents or inhibits the components from separating or cracking due to mechanical, thermal, and/or hydraulic stresses applied to the piping system. Separation of any of the components of the piping system or cracking of any element of the piping system may permit fluid to leak out of the piping system and, e.g., thereby damage the surrounding structure, e.g., the walls of a building which enclose the piping system.

Thermoplastic pipes (such as polyvinyl chloride (PVC) and/or chlorinated polyvinyl chloride (CPVC) pipes) may be subject to thermal expansion and/or contraction after installation. For example, a length of a thermoplastic pipe used for conveying fluid at an elevated temperature (e.g. hot water) may be subject to axial expansion and/or contraction based on the relative temperature of the fluid being conveyed, and the ends of the pipe may exert an axial force (either compressive or tensile) on the fittings, valves, or other parts of the piping system to which they are connected. Typically, hot water usage is intermittent. Therefore, hot water may be conveyed through a pipe for a period of time thereby heating the pipe. Subsequently, the flow of water will be terminated and the water in the pipe will cool as heat is dissipated to the ambient surrounding structure. This heating and cooling will cause the pipe to expand and contract axially. This cycle may be repeated several times a day or an hour. Continued thermal cycling of thermoplastic pipes (e.g., PVC and/or CPVC pipes) can result in a failure of the piping system and result in a leak if not supported by provision of expansion and contraction loop or off set.

Further, in a high rise building, plastic pipes that are mounted vertically to transport water between floors are mechanically constrained in their mechanical positions due to their mechanical attachment to transversely mounted pipes that deliver water horizontally to the various rooms or locations on the floors of the building. As such, when plastic pipes such as those made of PVC and CPVC are heated by the water that they transport, significant forces are created within the walls of the pipe due to the thermal expansion. These forces may exceed the buckling strength of the pipes, especially for pipe diameters under 5-6 inches, which may cause the plastic pipes to bend and/or buckle. This stress may result in a leak. Once an installation is complete (e.g., the interior walls of a building are finished or a piping system is buried under a road), accessing the piping system to repair a leak is typically time consuming and expensive.

Current state of the art discloses temperature or pressure dependent activation of adhesive that gives drawback of slow process of manufacturing and added cost to the process.

There is an indeed requirement of the technical advance process and product that are fast and provides economical advantage in the pipe with controlled diameter of the product.

### OBJECT OF INVENTION

A main object of the present invention is to provide CPVC multilayer composite pipe with improved temperature and de-lamination resistance.

Another object of present invention is to provide a method of manufacturing CPVC multilayer composite pipe with improved temperature and de-lamination resistance.

Further object of the present invention in the modification in the manufacturing process by providing the continuous monitoring system to measure the temperature of adhesive layer which is very important for better bonding, and there for provision of continuous external hot air blower setup to maintain the constant and precise temperature of adhesive layer for better bonding with CPVC layers for making composite pipe with improved temperature and de-lamination resistance.

Yet another object of the present invention is to provide CPVC composite pipe with metal interlayer having advantages like economical, versatile, durable and high tolerant at elevated conditions.

Yet another object of the present invention is to provide composite multilayer pipe with altered thickness to providing firm busing engagement at the end of pipe during installation application.

Further object of the present invention is to provide CPVC composite pipe with metal interlayer having high temperature and de-lamination resistance compared to current state of the art.

Yet another object of the present invention is to provide the composite pipe with being adhesively securely bonded two CPVC conduits with metal interlayer so as to meet required advanced ASTM D1784 standards and ASTM D2855 standards with Ring Peel Tests, Hydrostatic Sustained Pressure Testing, Izod impact test, deflection temperature under load.

Further object of the present invention is to provide CPVC composite pipe with metal interlayer that gives temperature resistance up to 95° C.

### SUMMARY OF INVENTION

The present invention relates to CPVC multilayer composite pipe with improved temperature and de-lamination resistance and process for making pipe. The present invention provides composite pipe with altered thickness having two conduits of CPVC separated by metal conduit. The invention provides pipe with multilayered structure having metal interlayer firm engagement through adhesive application. The process provides inventive intact arrangement of two different materials that are generally difficult to resists for clasping together in circular compact system specifically at elevated stressed conditions (i.e. temperature and pressure). In the current state of the art composite pipe manufacturing reflects de-lamination of the layers closely held together with adhesive application at interlayer. The present invention discloses CPVC composition along with adhesive which collectively provides superlative quality of holding dual layers of CPVC conduits with metal interlayer and low expansion to the pipe during elevated temperature and pressure conditions.

### DETAILED DESCRIPTION OF INVENTION

The nature of the invention and the manner in which it works is described in the provisional specification. The invention has various embodiments and they will more apparently describe in the complete specification. Before explaining the present invention, it is to be understood that the phraseology and terminology employed herein is for the purpose of description and not of limitation.

The present invention relates to multilayer composite CPVC pipe with metal interlayer having resistance to high temperature and de-lamination by change in the CPVC composition and steps of —application to secure higher resistance against de-lamination.

The glass transition temperature of the CPVC generally increases as the amount of chlorine increases, increased chlorine content causes the CPVC to become more difficult to process and products made therefrom to become more brittle.

The present invention utilises vinyl chloride homo-polymer compounds containing the vinyl chloride homo-polymer resin, and pipe made from such compounds, which meet 24448 cell classifications under ASTM D 1784.

The compounds employing such resins exhibit much improved chemical stability over standard vinyl chloride compounds. Thus, one aspect of the invention relates to a composite pipe prepared from an improved chlorinated vinyl chloride (CPVC) compound.

The CPVC compound can include at least one high molecular weight CPVC resin, wherein CPVC resin having chlorine content about 67-68% and the CPVC compound can additionally contain other additives. The other additive can include, for example, at least one of (i) stabilizers (ii) impact modifiers (iii) lubricants (iv) fillers (v) colorants, and (vi) combinations thereof.

In the present invention, the CPVC compound can contain from 4.5 to 9.5 phr of an impact modifier, which may include, for example, at least one of (i) acrylic impact modifiers, (ii) methyl butadiene styrene (MBS) impact modifiers, (iii) acrylonitrile butadiene styrene (ABS) impact modifiers, (iv) chlorinated polyethylene (CPE), or (v) combinations thereof.

In a further, the CPVC compound can include 3.0 phr or less of a lubricant, which may be, for example, at least one of (i) oxidized polyolefins, (ii) paraffin waxes, or (iii) combinations thereof. The object of the present invention is to prepared CPVC compound for desire property like improve in the impact and thermal property which meeting the requirements of 24448 cell classification.

The inner conduit is prepared by for making the composite pipe of arbitrary length, comprises, extruding a first conduit of chlorinated poly(vinyl chloride) in a first extruder at a temperature in the range from about 165° C.-212° C. that provide a hot inner conduit for the composite pipe, the inner conduit having a thickness in the range from 1.0 mm-2.5 mm;
feeding a strip of metal interlayer preferably aluminum metal, with adhesive to joint at interface on one sides of the first conduits, the metal having a thickness in the range from 0.15-0.43 mm;
laser welding the strip to close the gap without burning the inner conduit beneath to provide a continuously welded metal conduit closely encircling the inner conduit;
provide additional heating system to keep uniform temperature of outer metal conduit;
extruding a outer conduit of chlorinated poly(vinyl chloride) in a second extruder at a temperature in the range from about 182° C.-215° C. while exerting a vacuum annular space between the metal and the outer conduit being formed, so as to adhesively secure hot outer conduit to the metal, the outer conduit having a thickness in the range from 0.9-1.0 mm;
subsequent cooling the composite pipe to receive end product.

The present invention has specifically optimized the dimension of the composite pipe that focuses on increased the wall thickness at inner layer of the pipe and decrease the inside diameter of the pipe.

The changes have made for improving the flexibility of the pipe and reduce the cost of the pipe. The present invention has used Gluing of the Aluminum stripe during process. In state of the art Aluminum strip which is readily coated with Gluing. The use of adhesive on both the side of the Aluminum strips provide added advantage of elevated self life and lesser chances of hump effect or de-lamination of the metal and adjacent layers. The optimized process parameter and in-line adhesive application provides added advantage over the current state of the art.

The composite pipe particularly has crucial aspect for the bonding between CPVC and metal interlayer. The precise temperature control of CPVC conduit and metal layer during adhesive application along with dimension control provides unique advantage of flexibility and intactness of plastic and metal layer. The continuous monitoring system to measure the temperature of adhesive layer which is very important for better bonding, and there for provision of continuous external hot air blower setup to maintain the constant and precise temperature of adhesive layer for better bonding with CPVC layers for making composite pipe with improved temperature and de-lamination resistance.

PIPE DIMENSION AFTER MODIFICATION

| | |
|---|---|
| Outside Diameter | Inside Diameter |

| Size | Diameter | Tolerance | Diameter | Tolerance |
|---|---|---|---|---|
| 1½″ | 41.28 | 0.1 | 34.95 | 0.18 |
| 2″ | 53.98 | 0.1 | 46.6 | 0.2 |

WALL THICKNESS

| | Thickness | | Inner | Outer |
|---|---|---|---|---|
| Size | Aluminum | Tolerance | Diameter | Diameter |
| 1½″ | 0.19 | 0.05 | 1.50 | 0.93 |
| 2″ | 0.19 | 0.05 | 2.00 | 0.93 |

The dimension of the metal layer provides unique advantage for bending ability in composite pipe. The temperature expansion is also prevented by the sandwich arrangement of CPVC and metal layers.

The product is tested with various parameters and detailed testing parameters given as follows:

| SR. | | | TEST | TEST |
|---|---|---|---|---|
| NO. | TEST PARAMETER | UNIT | RESULT | METHOD |
| 1 | Density | gm/cc | 1.65 | ASTM D-792 |
| 2 | Tensile Strength at Break | MPa | 76 | ISO 527 |
| 3 | Izod Impact Strength | J/m | 598 | ASTM D-256 |
| 4 | Ring Stiffness load at 3% | N | 413 | 50 mm length |
| | compression | | | and |
| | | | | 2 mm/min |
| | | | | speed |
| 5 | Malfunction test at | | No leakage | ISO |
| | 95° C. temp, Duration | | or No | 15877 Part-1 |
| | 1000 hrs | | deformation | |
| | | | observed | |
| 6 | Apparent Tensile | N | 5300 | ASTM F 2855 |
| | strength of Tubing | | | |

Various testing were performed on multilayer composite finished pipe as per table-1.

1. Density:

The Density test was performed in accordance with ASTM D 792 for CPVC pipe and multi-layered pipe. The data show that the density of composite pipe is 1.65 gm/cc which is higher than the density of CPVC plain pipe 1.51 gm/cc due to metal layer specification in the composite pipe.

2. Tensile Strength at Break:

The tensile strength at break test performed in accordance with ASTM D-638 using type-I specimen with testing speed of 50 mm/min and the data shows the tensile strength of composite pipe is superior 76 Mpa than the CPVC plan pipe of 48 Mpa and the data indicate that a significant improvement in the tensile strength value were obtained due to specific dimension control over the CPVC layers and metal interlayer in the composite pipe. The optimized process parameter and in-line adhesive application provides added advantage over the current state of the art.

3. Izod Impact Strength:

Izod Impact strength test were performed in the Impactometer as per ASTM D-256 to examine the toughness of the pipe product and data shows higher impact strength 598 J/m in the composite pipe than CPVC pipe of 300 J/m. Further the product is tested for Falling dart impact evaluation which were performed on the both the pipes and measured the energy level and data shows higher energy level in the multilayer composite pipe.

4. Ring Stiffness Load at 3% Compression:

The ring stiffness test was performed at 3% compression on length sample with 2 mm/min speed. The data shows higher ring stiffness of composite pipe of 413 N which is higher than the CPVC pipe of 200 N indicate that the ring stiffness increase due to aluminium metal layer and dimension control of CPVC layers in the composite pipe.

Malfunction Test:

The malfunction test were performed as per ISO 15877 Part-1 with circulating water at 95° C. temperature and 1 MPa pressure for 1000 hrs. The data shows that no leakage or no deformation observed during prescribe duration in composite and CPVC plain pipe which indicate that both the pipe meets the requirement of ISO 15877 Part-1.

6. Apparent Tensile Strength for Tubing:

The Apparent Tensile strength of Tube ring were performed in accordance with ASTM F 2855, section 6.4. The data shows apparent tensile strength of composite pipe is 5300N which is just double than the specified requirement mention the ASTM F 2855 which indicate the perfect bonding of metal adhesive layer with the CPVC pipe.

7. Delamination Test:

The Delamination Test was carried out on composite pipe as per section 9.2 of ASTM F 2855 on 1″ ring size specimen. The band saw, slice each ring lengthwise into two approximately equal semi-circular, arc-shaped specimens. The slice on the second ring shall be at 90° from the slice on the first ring so that each of the four specimens represents one quadrant of the circumference of the pipe. In order to check delamination possibility the sample were treated with pliers grasp the opposing ends of arc and bend back the edges so that the outside edges of the arcs meet and the bent specimen is visually inspected. The results shows there is no any separation of the CPVC layer from either side of the aluminium observed due to specific bonding of the aluminium layer with CPVC layer.

The specific data pertaining to Coefficient of Linear thermal expansion provides indication about the thermal resistive property of the specific dimension control of the composite pipe.

| | | | OBTAINED RESULT | | |
|---|---|---|---|---|---|
| | | | CPVC | | |
| | | | composite | CPVC | |
| SR. | | | pipe | plain | |
| NO | TEST | UNIT | (Multilayer) | pipe | METHOD |
| 1 | Coefficient of | 10⁻⁵/° C. | 3.3 | 5.4 | ASTM E |
| | Linear | | | | 228 |
| | thermal | | | | |
| | expansion | | | | |

The inner conduit with higher thickness provides added advantage against the heat insulation and prevents the possible expansion or de-lamination due to high operative temperature.

The present process provides a composite pipe which is extruded so as to have (i) a metal interlayer sandwiched between (ii) an inner conduit chlorinated polyvinyl chloride (“CPVC”) adhesively secured to the inner surface of the metal interlayer, and (iii) an outer conduit of CPVC adhesively secured through adhesive to the outer surface of the metal conduit.

The product and manufacturing process of the present invention provides following advantages:
The present composite pipe have de-lamination resistance at alleviated external condition
Temperature resistance can be achieved up to 95° C.
Hump effect is minimized in the product
Low expansion in alleviated temperature condition
Complied with advanced ASTM D1784 standards and ASTM F2855 with Ring Peel Tests, Hydrostatic Sustained Pressure Testing, Izod impact test, deflection temperature under load.
Good flexibility in terms of bendability
The invention provides product that withstands structural settlement, high surge pressure and seismic loads.

The invention has been explained in relation to specific embodiment. It is inferred that the foregoing description is only illustrative of the present invention and it is not intended that the invention be limited or restrictive thereto. Many other specific embodiments of the present invention will be apparent to one skilled in the art from the foregoing disclosure. All substitution, alterations and modification of the present invention which come within the scope of the following claims are to which the present invention is readily susceptible without departing from the spirit of the invention. The scope of the invention should therefore be determined not with reference to the above description but should be determined with reference to appended claims along with full scope of equivalents to which such claims are entitled.

1-10. (canceled)

11. A CPVC multilayer composite pipe with improved impact resistance, temperature resistance and de-lamination resistance comprising:
at least one inner CPVC conduit, at least one metal interlayer and at least one outer layer CPVC conduit,
wherein at least one inner conduit, having a thickness in a range from 1.0 mm-2.5 mm, by making the composite pipe as extruding in a first conduit of chlorinated poly(vinyl chloride) in a first extruder at a temperature in the range from about 165° C.-212° C. that provide a hot inner conduit for the composite pipe,
wherein at least one strip of metal interlayer, to joint at interface on one side of the first conduits with adhesive, the metal having a thickness in the range from 0.15-0.43 mm,
wherein at least one outer conduit of chlorinated poly(vinyl chloride) exerting a vacuum annular space between the metal and the outer conduit being formed, so as to adhesively secure hot outer conduit to the metal, the outer conduit having a thickness in the range from 0.9-1.0 mm, and
wherein in line adhesive application is provided for bonding of two CPVC conduit with metal interlayer.

12. The CPVC multilayer composite pipe with improved impact resistance, temperature resistance and de-lamination resistance as claimed in claim 11, comprising CPVC resins having chlorine content in a range of 67-68% along with additives.

13. The CPVC multilayer composite pipe with improved impact resistance, temperature resistance and de-lamination resistance as claimed in claim 12, wherein additive includes stabilizers, impact modifiers, lubricants, fillers, colorants and/or combination of additives.

14. The CPVC multilayer composite pipe with improved impact resistance, temperature resistance and de-lamination resistance as claimed in claim 11, comprising aluminum as metal interlayer with a dimension of 0.19 mm.

15. The CPVC multilayer composite pipe with improved impact resistance, temperature resistance and de-lamination resistance as claimed in claim 11, comprising an apparent tensile strength of composite pipe in the range of 5200-5300N and ring stiffness in a range of 400-413 N.

16. The CPVC multilayer composite pipe with improved impact resistance, temperature resistance and de-lamination resistance as claimed in claim 11, comprising Izod Impact Strength impact strength in range of 560-598 J/m and tensile strength in a range of 70-76 Mpa.

17. The CPVC multilayer composite pipe with improved impact resistance, temperature resistance and de-lamination resistance as claimed in claim 11, comprising CPVC resin and additive with modification for desire property like improve in the impact and thermal property which meeting requirements of 24448 cell classification.

18. A process for A CPVC multilayer composite pipe with improved impact resistance, temperature resistance and de-lamination resistance comprising:
preparing inner CPVC conduit, having a thickness in a range from 1.0 mm-2.5 mm, by making the composite pipe as extruding a first conduit of chlorinated poly(vinyl chloride) in a first extruder at a temperature in the range from about 165° C.-212° C. that provide a hot inner conduit for the composite pipe,
feeding a strip of metal interlayer aluminum metal, with adhesive to joint at interface on one sides of the first conduits, the metal having a thickness in the range from 0.15-0.43 mm;
laser welding the strip to close a gap without burning the inner conduit beneath to provide a continuously welded metal conduit closely encircling the inner conduit;
heating system to keep uniform temperature of outer metal conduit;
extruding a outer conduit of chlorinated poly(vinyl chloride) in a second extruder at a temperature in the range from about 182° C.-215° C. while exerting a vacuum annular space between the metal and the outer conduit being formed, so as to adhesively secure hot outer conduit to the metal, the outer conduit having a thickness in the range from 0.9-1.0 mm; and
cooling the composite pipe to receive end product.

19. The process for A CPVC multilayer composite pipe with improved impact resistance, temperature resistance and de-lamination resistance as claimed in claim 18, in process or in-line adhesive application along with precise monitoring of temperature during process.

20. The process for A CPVC multilayer composite pipe with improved impact resistance, temperature resistance and de-lamination resistance as claimed in claim 18 wherein in line adhesive application has continuous external hot air blower setup to maintain a constant temperature of adhesive layer for better bonding with CPVC layers for making composite pipe with improved temperature and de-lamination.
